(19) United States
(12) Patent Application Publication
(10) Pub. No.: US 2009/0110789 A1
(43) Pub. Date: Apr. 30, 2009

(54) ANTIOXIDANT DRINK FOR DIETARY SUPPLEMENTATION

(75) Inventors: Thomas E. Mower, Springville, UT (US); Charles Jeffrey Brady, Provo, UT (US)

Correspondence Address: ALAN J. HOWARTH, P.O. BOX 1909, SANDY, UT, 84091-1909, US

(73) Assignee: SAKURA PROPERTIES, LLC, Salem, UT (US)

(21) Appl. No.: 12/144,420

(22) Filed: Jun. 23, 2008

Related U.S. Application Data
(60) Provisional application No. 60/936,960, filed on Jun. 22, 2007.

(51) Int. Cl. A23L 2/44; A23L 2/38; A23L 2/56

(52) U.S. Cl. 426/330.5; 426/542; 426/541; 426/330.3

(57) ABSTRACT

An antioxidant drink for dietary supplementation is described. The drink contains a broad spectrum of herbal antioxidants, including powders, concentrates, and extracts from green, purple, orange, and red fruits and vegetables. The supplement additionally may contain sweeteners, masking agents, and anti-bitterness agents to provide a palatable composition.

### CROSS-REFERENCE TO RELATED APPLICATIONS

This application claims the benefit of U.S. Provisional Application No. 60/936,960, filed Jun. 22, 2007, which is hereby incorporated by reference in its entirety.

### STATEMENT REGARDING FEDERALLY SPONSORED RESEARCH OR DEVELOPMENT

Not applicable.

### BACKGROUND OF THE INVENTION

This invention relates generally to dietary supplements. More particularly, the present invention relates to dietary supplements incorporating antioxidants, including herbal ingredients that have a high oxygen radical absorbance capacity (ORAC).

Antioxidants are substances found in the body and in foods that prevent cellular damage from reactive oxygen species (ROS) and free radicals. Reactive oxygen species include hydrogen peroxide and hypoclorous acid, as well as the free radicals, superoxide anion and hydroxyl radical. Free radicals are chemical species that have unpaired electrons. The presence of unpaired electrons renders free radicals highly reactive. Free radicals may arise from normal metabolism of the human body, such as when immune cells eliminate microbes. Free radicals also are acquired from insults from the environment, such as pollution, cigarette smoke, or sunlight. Exercise can also increase free radicals in the body. The main free radicals in the human body are reactive oxygen species.

When reactive oxygen species interact with cells in the body, oxidation occurs. This oxidation can damage healthy cells, membranes, and even DNA, which potentially may cause cells to grow abnormally, which is what cancer cells do. Reactive oxygen species can also cause oxidative stress, which has been associated with cardiovascular disease, neurodegenerative diseases, and cancer, as well as other pathologies. S. L. Williams et al., Antioxidant Requirements of Endurance Athletes: Implications for Health, 64 Nutrition Reviews 93-108 (2006).

Antioxidants may help reduce or prevent oxidative stress and damage to cells and cellular components caused by reactive oxygen species and free radicals in the body. The body has its own internal defense system of antioxidants, but nutritional supplementation with antioxidants is believed to bolster the body's defense system. Among the most common dietary antioxidants are vitamin E (α-tocopherol), vitamin C, and β-carotene, which have often been used as single supplements. These antioxidants have also been used in combinations with each other and with other antioxidants, such and coenzyme Q10 and selenium. Id. at 104.

While prior antioxidant nutritional supplement products are known and are generally suitable for their limited purposes, they possess certain inherent deficiencies that detract from their overall utility in supplementing diets with antioxidants. For example, nutritional supplement drinks that contain single antioxidants have suffered from a lack of synergy that may result from using combinations of antioxidants. Further, nutritional supplement drinks that are formulated with purified antioxidant ingredients lack the benefits that may be derived from herbal sources.

In view of the foregoing, it will be appreciated that providing an antioxidant-containing nutritional supplement drink containing a wide spectrum of antioxidant sources from different classes of herbal ingredients would be a significant advancement in the art.

### BRIEF SUMMARY OF THE INVENTION

An illustrative embodiment of the invention comprises a nutritional supplement drink comprising water, at least one antioxidant-containing herbal material selected from an orange fruit and vegetable group, and at least one antioxidant-containing herbal material selected from green, purple, or red fruit and vegetable groups. Illustrative members of the green fruit and vegetable group comprise lime powder, kiwi powder, green tea extract, white tea extract, coffee berry powder, broccoli powder, broccoli sprout extract, tomato powder, carrot powder, spinach powder, kale powder, Brussels sprout powder, onion extract, and mixtures thereof. Illustrative members of the purple fruit and vegetable group comprises black currant powder, bilberry extract, grade seed extract, mangosteen powder, acai powder, grape skin extract, wild blueberry extract, grape powder, cranberry powder, raspberry powder, raspberry seed extract, cranberry powder, prune powder, tart cherry powder, wild bilberry extract, strawberry powder, and mixtures thereof. Illustrative members of the orange fruit and vegetable group comprises grapefruit powder, mango powder, lemon powder, curcumin extract, sea buckthorn puree, and mixtures thereof. Illustrative members of the red fruit and vegetable group comprises strawberry powder, pomegranate powder, red raspberry concentrate, pine bark extract, wolfberry powder, cocoa powder, or mixtures thereof. Other illustrative embodiments of this invention can further comprise a flavoring agent, such as high fructose corn syrup, blueberry concentrate, pomegranate juice concentrate, red raspberry juice concentrate, Concord grape juice concentrate, gac fruit puree, oligofructose, fructose, vanilla flavor, thaumatin, or mixtures thereof. Still other illustrative embodiments of the invention can further comprise a thickener, such as acacia gum, sodium alginate, extract of Irish moss, panwar gum, ghatti gum, mucilage of isapol husks, xanthan gum, and mixtures thereof. Still other illustrative embodiments of the invention can comprise a preservative, such as sodium benzoate, potassium sorbate, methylparaben, or mixtures thereof.

Another illustrative embodiment according to the present invention comprises a nutritional supplement drink comprising water and at least one antioxidant-containing herbal material selected from each of green, purple, orange, and red fruit and vegetable groups.

Still another illustrative embodiment of the invention comprises a nutritional supplement drink comprising about 20.0 to 25.0 parts by weight of water, about 0.01 to about 1.0 parts by weight of an herbal material from the green fruit and vegetable group, about 0.01 to about 1.0 parts by weight of an herbal material from the purple fruit and vegetable group, about 0.01 to about 1.0 parts by weight of an herbal material from the orange fruit and vegetable group, and about 0.01 to about 1.0 parts by weight of a herbal material from the red fruit and vegetable group. Other illustrative embodiments of the invention further comprise about 1.0 to about 10.0 parts by weight of a flavoring agent. Still other illustrative embodiments of the invention further comprise about 0.001 to about 1.0 parts by weight of a thickener. Yet other illustrative embodiments of the invention further comprise about 0.001 to about 1.0 parts by weight of a preservative.

### DETAILED DESCRIPTION

Before the present antioxidant-containing dietary supplements and methods are disclosed and described, it is to be understood that this invention is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present invention will be limited only by the appended claims and equivalents thereof.

The publications and other reference materials referred to herein to describe the background of the invention and to provide additional detail regarding its practice are hereby incorporated by reference. The references discussed herein are provided solely for their disclosure prior to the filing date of the present application. Nothing herein is to be construed as an admission that the inventors are not entitled to antedate such disclosure by virtue of prior invention.

It must be noted that, as used in this specification and the appended claims, the singular forms “a,” “an,” and “the” include plural referents unless the context clearly dictates otherwise. Thus, for example, reference to a dietary supplement containing “a powder” includes a mixture of two or more of such powders, reference to “an antioxidant” includes reference to two or more of such antioxidants, and reference to “a preservative” includes reference to a mixture of two or more of such preservatives.

In describing and claiming the present invention, the following terminology will be used in accordance with the definitions set out below.

As used herein, “comprising,” “including,” “containing,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.”

As used herein, “high ORAC value” or similar terms means an ORAC value of at least about 400 per 100 grams of fruit or vegetable. ORAC units may also be expressed in terms of Trolox equivalents per gram (μmole TE/g). For example, blueberries have an ORAC value of about 2,400 per 100 grams, and the following fruits have ORAC values as shown in parentheses per 100 grams: blackberries (2,036), cranberries (1,750), strawberries (1,540), raspberries (1,220), plums (949), oranges (750), red grapes (739) cherries (670), kiwi fruit (602), and white grapes (446). Other fruits known to have a high ORAC value include black grapes, mangosteen, noni, aronia, wolfberry, and acai, and the like. Further, herbal ingredients known to have high ORAC values include proanthocyanidins, such as from extracts of grape seed and bark of white pine of southern Europe (e.g., pycnogenol, U.S. Pat. No. 4,698,360), and curcuminoids. Oligomeric proanthocyanidins (OPC) are illustrative.

As used herein, “sterilizing” and similar terms means, with respect to nutritional supplements having a pH less than 4.6 and a water activity greater than 0.85, pasteurizing the nutritional supplement and storing at room temperature. With respect to nutritional supplements having a pH greater than 4.6 and a water activity greater than 0.85, “sterilizing” and similar terms mean applying heat such that the nutritional supplement is rendered free of microorganisms capable of reproducing in the nutritional supplement under normal non-refrigerated conditions of storage and distribution.

As used herein, “pasteurization” traditionally means a process named after scientist Louis Pasteur by which every particle of milk is heated to not lower than 62.8° C. (i.e., 145° F.) for not less than 30 minutes and promptly cooled to destroy any harmful bacteria that may be present without affecting flavor and food value. Currently, the most common method of pasteurization in the United States is High Temperature Short Time (HTST) pasteurization, which uses metal plates and hot water to raise temperatures to 71.7° C. (i.e., 161° F.) for not less than 15 seconds, followed by rapid cooling. Ultra Pasteurization (UP) is a process similar to HTST pasteurization, but using higher temperatures and longer times. UP pasteurization results in a product with longer shelf life but still requiring refrigeration of milk, but not of acidified foods or nutritional supplements (pH <4.6). Another method, Ultra High Temperature (UHT) pasteurization, raises the temperature to over 93.3° C. (i.e., 200° F.) for a few seconds, followed by rapid cooling. A UHT-pasteurized product that is packaged aseptically results in a “shelf stable” product that does not require refrigeration until it is opened.

As used herein, “aseptic processing and packaging” and similar terms mean the filling of a sterilized cooled product into pre-sterilized containers, followed by aseptic hermetic sealing, with a pre-sterilized closure, in an atmosphere free of microorganisms.

As used herein, “hermetically sealed container” and similar terms mean a container that is designed and intended to be secure against the entry of microorganisms and thereby to maintain the sterility of its contents after processing.

As used herein, “flavoring agents” vary considerably in their chemical structure, ranging from simple esters, alcohols, and aldehydes to carbohydrates and complex volatile oils. Natural and synthetic flavors of almost any desired type are now available.

As used herein, “Brix” is a scale for measuring the sugar content of grapes, wine, and the like. Each degree of Brix is equivalent to one gram of sugar per 100 ml of liquid. Thus, an 18 degree Brix sugar solution contains 18% by weight of sugar. Brix also describes the percent of suspended solids in a liquid. Thus, 95 Brix, for example, denotes a liquid that contains 95% by weight of suspended solids. Brix is measured with an optical device called a refractometer. The Brix system of measurement is named for A.F.W. Brix, a 19^{th} century German inventor.

Many antioxidant dietary supplements currently on the market contain a predominant antioxidant source. For example, there are products that rely principally on mangosteen and others that rely principally on wolfberry. The present invention provides a broad spectrum of antioxidant sources. A rationale for this approach is to provide a broad spectrum of types of antioxidants. More particularly, there is evidence to suggest that antioxidants from sources having blue or purple fruits tend to contain similar types of antioxidants. This concept has been expanded in the present invention to provide antioxidants from sources that have several different colors of fruits or vegetables. Namely, the present invention includes antioxidants from sources that have been termed green, purple, orange, and red food sources.

Green food sources of antioxidants include fruits or vegetables where the fruits or vegetables are green in color. Illustrative greed food sources include lime, kiwi, green tea (Camellia sinensis), white tea, coffee berry, and vegetables, and the like. Lime powder may be made by freeze drying of lime fruits. Kiwi powder may be made by freeze drying of kiwi fruit. Green tea extract may be made by aqueous extraction of dried leaves. A typical commercially available preparation of green tea extract contains greater than 50% by weight of polyphenols and greater than 25% by weight of tea catechins. White tea extract may be made by extracting dried tea (Camellia sinensis) leaves with water. A typical commercially available preparation of white tea extract contains at least 50% caffeine. Coffee berry powder is made from green coffee berries. A typical commercially available preparation contains a minimum of 2.0% by weight of total phenolic acids and has an ORAC value of at least 800 μmole TE/g. Vegetable extracts that are high in ORAC value are available commercially. A typical all-vegetable antioxidant blend contains vegetable concentrates plus concentrated freeze dried vegetable powders and has an ORAC value of at least 5000 μmole TE/g, a glucosinolates concentration of at least 2000 ppm, a sulphoraphane potential of at least 1000 ppm, a lycopene concentration of at least 100 ppm, and a lutein concentration of at least 100 ppm. This illustrative vegetable concentrate contains broccoli powder, broccoli sprout extract, tomato powder, carrot powder, spinach powder, kale powder, Brussels sprout powder, and onion extract.

Purple food sources of antioxidants include fruits that are blue or purple in color. Illustrative purple food sources include blueberry fruits, black currant fruits, bilberry (Vaccinium myrtillus) fruits, grape (Vitis vinifera) seed extract, grape concentrate, mangosteen, acai, and grape (Vitis vinifera) skin powder extract, and the like. Blueberry extracts may be made from blueberry fruits. Blueberries provide among the highest ORAC values of any known fruit or vegetable. Blueberries contain such nutrients as anthocyanins, chlorogenic acid, ellagic acid, catechins, and resveratrol. Black currant powder may be made from freeze dried black currant fruits. Bilberry extract may be made by a hydroalcoholic extract of dried bilberry fruits. A typical commercially available preparation contains at least 25% by weight of anthocyanins. Grape seed extract may be made by hydroalcoholic extraction of dried grape seeds. A typical commercial preparation contains at least 95% by weight of proanthocyanins. Mangosteen powder may be made from mangosteen (Garcinia mangostana) fruits. A typical commercially available preparation contains an ORAC value of at least 300 μmole TE/g. Acai powder is made from freeze dried acai fruits. A typical commercially available preparation contains at least 1.0% by weight of anthocyanins and at least 3% by weight of total phenols and has an ORAC value of at least 600 μmole TE/g. Grape skin powder extract may be made as a hydroalcoholic extract of grape skins. A typical commercially available preparation of grape skin powder contains at least 40% by weight of polyphenols and at least 10% by weight of resveratrol and has an ORAC value of at least 5,800 μmoles TE/g. In an illustrative embodiment of the present invention, a commercially available blend of freeze dried whole fruit powders and extracts may be added. An illustrative blend contains wild blueberry extract, cranberry, raspberry and raspberry seed extract, strawberry powder, prune, tart cherry, wild bilberry extract, and grape and grape seed extract. This blend contains at least 30% of total polyphenols and has an ORAC value of at least 6000 μmole TE/g.

Orange food sources of antioxidants include fruits that are orange or yellow in color. Illustrative orange food sources include grapefruit, mango, lemon, curcumin (Curcumin longa) roots and rhizomes, and sea buckthorn, and the like. Grapefruit extract may be made by freeze drying of grapefruit fruits. Mango powder may be made by freeze drying of mango fruits. Lemon powder may be made by freeze drying of lemon fruits. Curcumin extract may be made from Curcuma longa roots and rhizomes. A typical commercial preparation contains at least 95% curcuminoids, including at least 2.5% by weight of bismethoxy curcumin, at least 15.0% by weight of demethoxy curcumin, and 70.0% by weight of curcumin. Seabuckthorn is commercially available as a puree containing a total acid content of at least about 2.5% by weight.

Red food sources of antioxidants include fruits that are red in color. Illustrative red food sources include strawberry, pomegranate, raspberry, pine bark, wolfberry, and cocoa, and the like. Strawberry may be added as a freeze dried powder of strawberry fruits. Pomegranate may be supplied as a pomegranate juice concentrate or as a freeze dried powder made from pomegranate fruits. Raspberry may be added as a powder made from raspberry fruits. A typical commercially available preparation contains at least 20% by weight of ellagic acid and at least 0.7% by weight of anthocyanins and also has an ORAC value of at least 200 μmole TE/g. Pine bark extract may be made by hydroalcoholic extraction of dried bark of Pinus massoniana. A typical commercial preparation of pine bark extract contains at least 95% by weight of proanthocyanidins. Wolfberry powder is commercially available. Cocoa contains a very high ORAC value. A typical commercially available preparation of cocoa powder contains a cocoa butter content of at least 10% by weight.

Some antioxidants have a bitter taste, which can detract from the their overall utility in dietary supplement drinks. Accordingly, in the present invention flavoring agents are provided improve the flavor of the supplement, which makes it more palatable to consumers. Flavoring agents that may be used include sweeteners, masking agents, anti-bitterness agents, and the like. Sweeteners can include saccharides, such as monosaccharides (simple sugars) and oligosaccharides. Although artificial sweeteners could be used, they are usually avoided in dietary supplements because of negative perceptions by consumers of supplements, who often view artificial ingredients with disdain. Monosaccharides include simple sugars, such as fructose (fruit sugar) and glucose. For example, fructose can be provided in the form of high fructose corn syrup. Oligosaccharides include cane sugar, which is a disaccharide composed of glucose and fructose units. Another oligosaccharide is oligofructose, such as is available in a commercial product containing a mixture of at least 52% by weight of oligofructose and at least 46% by weight of fructose. Other sweeteners that may be used according to the present invention include fruit juice concentrates, fruit purees, and concentrates of mixed fruits. Examples of these sweeteners include blueberry concentrate 65 Brix, pomegranate juice concentrate 65 Brix, red raspberry juice concentrate 65 Brix, Concord grape juice concentrate 68 Brix, apple juice concentrate, and a fruit concentrate blend containing juices of plum, grape, black currant, and blueberry. Another advantageous sweetener is a puree of the gac (Momordica cochinchinensis) fruit. Gac fruits are grown on climbing vines in Southeast Asia. The gac fruit contains high concentrations of P-carotene, and the aril contains high concentrations of lycopene. Masking agents include products that mask the bitterness of some of the antioxidant. Masking agents can include glycyrrhizin, natural vanilla flavor, and the like. Anti-bitterness agents may be included for diminishing or neutralizing the bitterness of some antioxidants. Illustrative anti-bitterness agents comprise thaumatin-containing protein extract from katemfe fruit (Thaumatococcus danielli) and bitterness and acidity suppressor flavor powder (Bell Flavors & Fragrances, Inc., Northbrook, Ill.). Some high-ORAC fruits contain flavors that aid in sweetening or masking the bitter flavor of other antioxidants.

It is also advantageous to add other ingredients, such as thickeners, preservatives, and the like, to illustrative embodiments of the invention. Illustrative thickeners include natural gums, such as acacia, sodium alginate, extract of Irish moss, panwar gum, ghatti gum, mucilage of isapol husks, xanthan powder, and the like. Illustrative preservatives include sodium benzoate, potassium sorbate, and methylparaben, and the like.

Substantially pure water, such as deionized water or reverse osmosis (RO) water, is also an important ingredient of illustrative embodiments of the present invention.

The supplement drink is made by mixing the various ingredients together in selected amounts. Next, the mixture is sterilized by pasteurization or other heating techniques. Although pasteurization (at least 87.8° C. or 190° F.) effectively eliminates pathogenic microorganisms, sterilization at higher temperatures maybe needed to eliminate all microorganisms.

In achieving the necessary sterilization, two different sterilization processes are typically used. Using the HTST (high temperature short time) process, the mixture may be raised to about 85° C. (185° F.) for about 20-30 seconds. Alternately, the ultra-high temperature (UHT) process involves raising the temperature of the mixture to about 140.6° C. (285° F.) for about 4-6 seconds. In either process, immediately after the heating step, the temperature is rapidly lowered to at least ambient temperatures of about 21.1-26.7° C. (70-80° F.). Alternately, the mixture may be chilled down to about 4.4° C. (40° F.).

Heating of the mixture may be accomplished by direct or indirect heating. For example, the mixture may be heated by direct contact with steam or indirectly by a selected type of heat exchanger.

The sterilized blend may then be poured into containers, using a hot-fill or cold-fill method. In the hot-fill process, the product is first heated to temperatures for pasteurization, HTST, or UHT. Then it is poured into containers at elevated temperatures to kill any microorganisms inside the container. The use of preservatives, such as sodium benzoate and potassium sorbate are normally used. After filling, the bottles may be cooled slowly by a water mist. Filling of containers is done by aseptic processing and packaging methods, which are well known in the art.

In the cold-fill process, after pasteurization or sterilization temperatures are reached, the product is immediately cooled to about room temperature prior to bottling, using aseptic processing and packaging techniques. Immediate cooling allows less vitamin degradation and variations in flavor that may be found in the hot-fill process. Thus, in cold-fill processing the flavor may be cleaner and fresher. Preservatives are usually included to control the growth of yeast, molds, and bacteria.

The cold-fill process is compatible with use of high-density polyethylene (HDPE) or polyethylene terephthalate (PET) bottling, so as to not compromise the integrity of the bottle structure. The bottles may be 1000 ml bottles. This size would provide sufficient beverage for about 33 days, based on a recommended daily dosage of about 30 ml.

### EXAMPLES

The following are examples of antioxidant nutritional supplements according to the present invention. These examples are merely illustrative and are not meant to be limiting in any way.

The present invention may be embodied in other specific forms without departing from its spirit or essential characteristics. The described embodiments are to be considered in all respects only as illustrative and not restrictive. The scope of the invention is, therefore, indicated by the appended claims, rather than by the description or examples. All changes that come within the meaning and range of equivalency of the claims are to be embraced within their scope.

### Example 1

An embodiment of the present invention comprises 20.0 parts by weight of water, 0.05 parts by weight of lime powder, 0.05 parts by weight of grape seed extract, 0.05 parts by weight of lemon powder, and 0.05 parts by weight of wolfberry extract.

### Example 2

An embodiment of the present invention comprises 25.0 parts by weight of water, 0.9 parts by weight of sea buckthorn puree, and 0.9 parts by weight of coffee berry concentrate.

### Example 3

An embodiment of the present invention comprises 21.25 parts by weight of water, 0.25 parts by weight of curcumin extract, and 0.75 parts by weight of acai powder.

### Example 4

An embodiment of the present invention comprises 24.763 parts by weight of water, 0.100 parts by weight of mango powder, and 0.100 parts by weight of pine bark extract.

### Example 5

An embodiment of the present invention comprises 21.713 parts by weight of water, 0.010 parts by weight of lime powder, 0.3 parts by weight of kiwi powder, 0.001 to about 0.15 parts by weight of green tea extract, 0.005 parts by weight of white tea extract, 0.100 parts by weight of coffee berry powder, 0.002 parts by weight of broccoli powder, 0.002 parts by weight of broccoli sprout extract, 0.002 parts by weight of tomato powder, 0.002 parts by weight of carrot powder, 0.002 parts by weight of spinach powder, 0.002 parts by weight of kale powder, 0.002 parts by weight of Brussels sprout powder, 0.002 parts by weight of onion extract, 0.050 parts by weight of black currant powder, 0.15 parts by weight of bilberry extract, 0.015 parts by weight of grape seed extract, 0.3 parts by weight of mangosteen powder, 0.050 parts by weight of acai powder, 0.15 parts by weight of grape skin extract, 0.005 parts by weight of wild blueberry extract, 0.05 parts by weight of grape powder, 0.05 parts by weight of cranberry powder, 0.05 parts by weight of raspberry powder, 0.05 parts by weight of raspberry seed extract, 0.05 parts by weight of cranberry powder, 0.05 parts by weight of prune powder, 0.05 parts by weight of tart cherry powder, 0.05 parts by weight of wild bilberry extract, 0.05 parts by weight of strawberry powder, 0.001 parts by weight of grapefruit powder, 0.3 parts by weight of mango powder, 0.001 parts by weight of lemon powder, 0.15 parts by weight of curcumin extract, 0.001 parts by weight of sea buckthorn puree, 0.3 parts by weight of strawberry powder, 0.001 parts by weight of pomegranate powder, 0.100 parts by weight of red raspberry concentrate, 0.001 parts by weight of pine bark extract, 1.5 parts by weight of wolfberry powder, 0.100 parts by weight of cocoa powder, 5.0 parts by weight of high fructose corn syrup, 0.1 parts by weight of blueberry concentrate, 0.1 parts by weight of pomegranate juice concentrate, 1.0 parts by weight of red raspberry juice concentrate, 1.0 part by weight of Concord grape juice concentrate, 0.200 parts by weight of gac fruit puree, 1.0 part by weight of oligofructose and fructose mixture, 0.010 parts by weight of vanilla flavor, 0.010 parts by weight of xanthan gum, 0.010 parts by weight of sodium benzoate, and 0.001 parts by weight of thaumatin.

### Example 6

An embodiment of the present invention comprises 23.173 parts by weight of water, 0.03 parts by weight of lime powder, 0.03 parts by weight of kiwi powder, 0.015 parts by weight of green tea extract, 0.015 parts by weight of white tea extract, 0.015 parts by weight of coffee berry powder, 0.001875 parts by weight of broccoli powder, 0.001875 parts by weight of broccoli sprout extract, 0.001875 parts by weight of tomato powder, 0.001875 parts by weight of carrot powder, 0.001875 parts by weight of spinach powder, 0.001875 parts by weight of kale powder, 0.001875 parts by weight of Brussels sprout powder, 0.001875 parts by weight of onion extract, 0.060 parts by weight of black currant powder, 0.015 parts by weight of bilberry extract, 0.015 parts by weight of grape seed extract, 0.03 parts by weight of mangosteen powder, 0.015 parts by weight of acai powder, 0.015 parts by weight of grape skin extract, 0.006 parts by weight of wild blueberry extract, 0.006 parts by weight of grape powder, 0.006 parts by weight of cranberry powder, 0.006 parts by weight of raspberry powder, 0.006 parts by weight of raspberry seed extract, 0.006 parts by weight of cranberry powder, 0.006 parts by weight of prune powder, 0.006 parts by weight of tart cherry powder, 0.006 parts by weight of wild bilberry extract, 0.006 parts by weight of strawberry powder, 0.03 parts by weight of grapefruit powder, 0.03 parts by weight of mango powder, 0.0045 parts by weight of lemon powder, 0.015 parts by weight of curcumin extract, 0.015 parts by weight of sea buckthorn puree, 0.03 parts by weight of strawberry powder, 0.03 parts by weight of pomegranate powder, 0.15 parts by weight of red raspberry concentrate, 0.015 parts by weight of pine bark extract, 0.15 parts by weight of wolfberry powder, 0.15 parts by weight of cocoa powder, 2.250 parts by weight of high fructose corn syrup, about 0.9 parts by weight of blueberry concentrate, 0.9 parts by weight of pomegranate juice concentrate, 0.6 parts by weight of red raspberry juice concentrate, 0.6 parts by weight of Concord grape juice concentrate, 0.30 parts by weight of gac fruit puree, 0.2820 parts by weight of oligofructose and fructose mixture, 0.015 parts by weight of vanilla flavor, 0.012 parts by weight of xanthan gum, 0.018 parts by weight of sodium benzoate, and 0.0001 parts by weight of thaumatin-containing extract.

### Example 7

An illustrative embodiment of the invention comprises 22.847 parts by weight of water, 0.0309 parts by weight of lime powder, 0.0309 parts by weight of kiwi powder, 0.0155 parts by weight of green tea extract, 0.0155 parts by weight of white tea extract, 0.0155 parts by weight of coffee berry powder, 0.002 parts by weight of broccoli powder, 0.002 parts by weight of broccoli sprout extract, 0.002 parts by weight of tomato powder, 0.002 parts by weight of carrot powder, 0.002 parts by weight of spinach powder, 0.002 parts by weight of kale powder, 0.002 parts by weight of Brussels sprout powder, 0.002 parts by weight of onion extract, 0.0618 parts by weight of black currant powder, 0.0155 parts by weight of bilberry extract, 0.0155 parts by weight of grape seed extract, 0.0309 parts by weight of mangosteen powder, 0.0155 parts by weight of acai powder, 0.0155 parts by weight of grape skin extract, 0.0062 parts by weight of wild blueberry extract, 0.0062 parts by weight of grape powder, 0.0062 parts by weight of cranberry powder, 0.0062 parts by weight of raspberry powder, 0.0062 parts by weight of raspberry seed extract, 0.0062 parts by weight of cranberry powder, 0.0062 parts by weight of prune powder, 0.0062 parts by weight of tart cherry powder, 0.0062 parts by weight of wild bilberry extract, 0.0062 parts by weight of strawberry powder, 0.0309 parts by weight of grapefruit powder, 0.0309 parts by weight of mango powder, 0.0046 parts by weight of lemon powder, 0.0155 parts by weight of curcumin extract, 0.0155 parts by weight of sea buckthorn puree, 0.0309 parts by weight of strawberry powder, 0.0309 parts by weight of pomegranate powder, 0.1545 parts by weight of red raspberry concentrate, 0.0155 parts by weight of pine bark extract, 0.1545 parts by weight of wolfberry powder, 3.708 parts by weight of apple juice concentrate, 0.927 parts by weight of blueberry concentrate, 0.927 parts by weight of pomegranate juice concentrate, 0.618 parts by weight of red raspberry juice concentrate, 0.618 parts by weight of Concord grape juice concentrate, 0.309 parts by weight of gac fruit puree, 0.0695 parts by weight of bitterness and acid suppressor powder, 0.0155 parts by weight of vanilla flavor, 0.0185 parts by weight of xanthan gum, and 0.0185 parts by weight of sodium benzoate.

The subject matter claimed is:

1. A nutritional supplement drink comprising water and at least one antioxidant-containing herbal material selected from each of green, purple, orange, and red fruit and vegetable groups.

2. The nutritional supplement drink of claim 1 wherein the green fruit and vegetable group comprises lime powder, kiwi powder, green tea extract, white tea extract, coffee berry powder, broccoli powder, broccoli sprout extract, tomato powder, carrot powder, spinach powder, kale powder, Brussels sprout powder, onion extract, and mixtures thereof.

3. The nutritional supplement drink of claim 1 wherein the purple fruit and vegetable group comprises black currant powder, bilberry extract, grade seed extract, mangosteen powder, acai powder, grape skin extract, wild blueberry extract, grape powder, cranberry powder, raspberry powder, raspberry seed extract, cranberry powder, prune powder, tart cherry powder, wild bilberry extract, strawberry powder, and mixtures thereof.

4. The nutritional supplement drink of claim 1 wherein the orange fruit and vegetable group comprises grapefruit powder, mango powder, lemon powder, curcumin extract, sea buckthorn puree, and mixtures thereof.

5. The nutritional supplement drink of claim 1 wherein the red fruit and vegetable group comprises strawberry powder, pomegranate powder, red raspberry concentrate, pine bark extract, wolfberry powder, cocoa powder, and mixtures thereof.

6. The nutritional supplement drink of claim 1 further comprising a flavoring agent.

7. The nutritional supplement drink of claim 6 wherein the flavoring agent is a member selected from the group consisting of high fructose corn syrup, blueberry concentrate, pomegranate juice concentrate, red raspberry juice concentrate, Concord grape juice concentrate, gac fruit puree, oligofructose, fructose, vanilla flavor, thaumatin, and mixtures thereof.

8. The nutritional supplement drink of claim 1 further comprising a thickener.

9. The nutritional supplement drink of claim 8 wherein the thickener is a member selected from the group consisting of acacia gum, sodium alginate, extract of Irish moss, panwar gum, ghatti gum, mucilage of isapol husks, xanthan gum, and mixtures thereof.

10. The nutritional supplement drink of claim 1 further comprising a preservative.

11. The nutritional supplement drink of claim 10 wherein the preservative is a member selected from the group consisting of sodium benzoate, potassium sorbate, methylparaben, and mixtures thereof.

12. A nutritional supplement drink comprising about 23.173 parts by weight of water, about 0.120 parts by weight of one or more antioxidant-containing herbal materials from a green fruit and vegetable group, about 0.210 parts by weight of one or more antioxidant-containing herbal materials from a purple fruit and vegetable group, about 0.0945 parts by weight of one or more antioxidant-containing herbal materials from an orange fruit and vegetable group, and about 0.525 parts by weight of one or more antioxidant-containing herbal materials from a red fruit and vegetable group.

13. The nutritional supplement drink of claim 12 further comprising about 5.8471 parts by weight of a flavoring agent.

14. The nutritional supplement drink of claim 12 further comprising about 0.012 parts by weight of a thickener.

15. The nutritional supplement drink of claim 12 further comprising about 0.018 parts by weight of a preservative.

16. A nutritional supplement drink comprising about 20.0 to 25.0 parts by weight of water, about 0.01 to about 1.0 parts by weight of an herbal material from a green fruit and vegetable group, about 0.01 to about 1.0 parts by weight of an herbal material from a purple fruit and vegetable group, about 0.01 to about 1.0 parts by weight of an herbal material from an orange fruit and vegetable group, and about 0.01 to about 1.0 parts by weight of an herbal material from a red fruit and vegetable group.

17. The nutritional supplement drink of claim 16 further comprising about 1.0 to about 10.0 parts by weight of a flavoring agent.

18. The nutritional supplement drink of claim 16 further comprising about 0.001 to about 1.0 parts by weight of a thickener.

19. The nutritional supplement drink of claim 16 further comprising about 0.001 to about 1.0 parts by weight of a preservative.

20. A nutritional supplement drink comprising about 20.0 to about 25.0 parts by weight of water, about 0.001 to about 0.3 parts by weight of lime powder, about 0.001 to about 0.3 parts by weight of kiwi powder, about 0.001 to about 0.15 parts by weight of green tea extract, about 0.001 to about 0.15 parts by weight of white tea extract, about 0.001 to about 0.15 parts by weight of coffee berry powder, about 0.001 to about 0.1 parts by weight of broccoli powder, about 0.001 to about 0.1 parts by weight of broccoli sprout extract, about 0.001 to about 0.1 parts by weight of tomato powder, about 0.001 to about 0.1 parts by weight of carrot powder, about 0.001 to about 0.1 parts by weight of spinach powder, about 0.001 to about 0.1 parts by weight of kale powder, about 0.001 to about 0.1 parts by weight of Brussels sprout powder, about 0.001 to about 0.1 parts by weight of onion extract, about 0.005 to about 0.5 parts by weight of black currant powder, about 0.001 to about 0.15 parts by weight of bilberry extract, about 0.001 to about 0.15 parts by weight of grape seed extract, about 0.001 to about 0.3 parts by weight of mangosteen powder, about 0.001 to about 0.15 parts by weight of acai powder, about 0.001 to about 0.15 parts by weight of grape skin extract, about 0.005 to about 0.05 parts by weight of wild blueberry extract, about 0.005 to about 0.05 parts by weight of grape powder, about 0.005 to about 0.05 parts by weight of cranberry powder, about 0.005 to about 0.05 parts by weight of raspberry powder, about 0.005 to about 0.05 parts by weight of raspberry seed extract, about 0.005 to about 0.05 parts by weight of cranberry powder, about 0.005 to about 0.05 parts by weight of prune powder, about 0.005 to about 0.05 parts by weight of tart cherry powder, about 0.005 to about 0.05 parts by weight of wild bilberry extract, about 0.005 to about 0.05 parts by weight of strawberry powder, about 0.001 to about 0.3 parts by weight of grapefruit powder, about 0.001 to about 0.3 parts by weight of mango powder, about 0.0005 to about 0.05 parts by weight of lemon powder, about 0.001 to about 0.15 parts by weight of curcumin extract, about 0.001 to about 0.15 parts by weight of sea buckthorn puree, about 0.001 to about 0.3 parts by weight of strawberry powder, about 0.001 to about 0.3 parts by weight of pomegranate powder, about 0.01 to about 1.5 parts by weight of red raspberry concentrate, about 0.001 to about 0.15 parts by weight of pine bark extract, about 0.01 to about 1.5 parts by weight of wolfberry powder, about 0.01 to about 1.5 parts by weight of cocoa powder, about 0.1 to about 5.0 parts by weight of high fructose corn syrup, about 0.1 to about 5.0 parts by weight of blueberry concentrate, about 0.1 to about 5.0 parts by weight of pomegranate juice concentrate, about 0.05 to about 5.0 parts by weight of red raspberry juice concentrate, about 0.05 to about 5.0 parts by weight of Concord grape juice concentrate, about 0.02 to about 3.0 parts by weight of gac fruit puree, about 0.02 to about 3.0 parts by weight of oligofructose and fructose mixture, about 0.001 to about 0.15 parts by weight of vanilla flavor, about 0.001 to about 0.1 parts by weight of xanthan gum, about 0.001 to about 0.2 parts by weight of sodium benzoate, and about 0.00001 to about 0.001 parts by weight of thaumatin.

21. A nutritional supplement drink comprising water, at least one antioxidant-containing herbal material selected from an orange fruit and vegetable group, and at least one antioxidant-containing herbal material selected from green, purple, or red fruit and vegetable groups.

22. The nutritional supplement drink of claim 21 wherein the orange fruit and vegetable group comprises grapefruit powder, mango powder, lemon powder, curcumin extract, sea buckthorn puree, and mixtures thereof.

23. The nutritional supplement drink of claim 21 wherein the green fruit and vegetable group comprises lime powder, kiwi powder, green tea extract, white tea extract, coffee berry powder, broccoli powder, broccoli sprout extract, tomato powder, carrot powder, spinach powder, kale powder, Brussels sprout powder, onion extract, and mixtures thereof

24. The nutritional supplement drink of claim 21 wherein the purple fruit and vegetable group comprises black currant powder, bilberry extract, grade seed extract, mangosteen powder, acai powder, grape skin extract, wild blueberry extract, grape powder, cranberry powder, raspberry powder, raspberry seed extract, cranberry powder, prune powder, tart cherry powder, wild bilberry extract, strawberry powder, and mixtures thereof.

25. The nutritional supplement drink of claim 21 wherein the red fruit and vegetable group comprises strawberry powder, pomegranate powder, red raspberry concentrate, pine bark extract, wolfberry powder, cocoa powder, and mixtures thereof.

26. The nutritional supplement drink of claim 21 further comprising a flavoring agent.

27. The nutritional supplement drink of claim 26 wherein the flavoring agent is a member selected from the group consisting of high fructose corn syrup, blueberry concentrate, pomegranate juice concentrate, red raspberry juice concentrate, Concord grape juice concentrate, gac fruit puree, oligofructose, fructose, vanilla flavor, thaumatin, and mixtures thereof.

28. The nutritional supplement drink of claim 21 further comprising a thickener.

29. The nutritional supplement drink of claim 28 wherein the thickener is a member selected from the group consisting of acacia gum, sodium alginate, extract of Irish moss, panwar gum, ghatti gum, mucilage of isapol husks, xanthan gum, and mixtures thereof.

30. The nutritional supplement drink of claim 21 further comprising a preservative.

31. The nutritional supplement drink of claim 30 wherein the preservative is a member selected from the group consisting of sodium benzoate, potassium sorbate, methylparaben, and mixtures thereof.
